(19) United States
(12) Patent Application Publication
(10) Pub. No.: US 2020/0110841 A1
(43) Pub. Date: Apr. 9, 2020

(54) EFFICIENT MINING OF WEB-PAGE RELATED MESSAGES

(71) Applicant: CA, Inc., New York, NY (US)

(72) Inventors: Corey Adam Cohen, Matawan, NJ (US); Erhan Giral, Saratoga, CA (US)

(21) Appl. No.: 16/155,268

(22) Filed: Oct. 9, 2018

(51) Int. Cl. G06F 17/30; G06F 17/27; G06K 9/62; G06F 17/18

(52) U.S. Cl. CPC G06F 17/30864; G06F 17/18; G06K 9/6267; G06F 17/277

(57) ABSTRACT

To extract meaningful information that aids in analysis of a web application or web site based on page summarizations without impractical resource demand, statistical modeling is employed to approximately identify pages across web application transactions and predict meaningful content or items of information within the pages. Statistics are collected on a sample of traffic for a web application. The collected statistics are on tokens generated from messages that correspond to web pages. Statistics are collected by message, by transaction, and across the sampling of messages. Descriptive tokens that meaningfully describe a web page and attribute-value pair tokens are scored. Those of the tokens that satisfy selection criteria are selected as a basis for generating extraction rules. Subsequently, the extraction rules are applied to message payloads to efficiently extract descriptive “tags” and attribute-value pairs.

### BACKGROUND

The disclosure generally relates to the field of data processing, and more particularly to software development, installation, and management.

Text data mining or text mining involves examining large collections of unstructured text and transforming it into structured data for use in further analysis. Although text mining and natural language processing (NLP) are different technologies, they complement each other. NLP can be used for text mining and text mining can be used for NLP.

NLP technology is used to enable a computer to derive meaning from human language in a useful way. More specifically, NLP technology is used to organize and structure text to perform tasks. Some of these tasks include automatic summarization, translation, named entity recognition, relationship extraction, sentiment analysis, speech recognition, and topic segmentation. Low-level NLP tasks include sentence boundary detection, tokenization, part-of-speech assignment to individual words (‘POS tagging’), morphological decomposition of compound words, lemmatization, chunking, and problem-specific segmentation.

NLP is applied to text that does not conform to the grammar and structure of human language, such as programming language text. Web scraping employs NLP for text mining web pages. NLP toolkits can be used to remove boilerplate (e.g., navigation bars, headers, footers, etc.) and then extract specified text from the remaining text.

### BRIEF DESCRIPTION OF THE DRAWINGS

Embodiments of the disclosure may be better understood by referencing the accompanying drawings.

FIG. 1 is a diagram of a system that summarizes information from web page related messages for efficient extraction of meaningful information from web page related messages.

FIG. 2 is a flowchart of example operations for identifying meaningful information in web page related payloads of messages of a web application or website.

FIG. 3 is a flowchart of example operations for generating extraction rules based on attribute-value pairs that satisfied scoring based selection criterion.

FIG. 4 is a flowchart of example operations for extraction rule based mining of web page related payloads of request and response messages of a web application or website.

FIG. 5 depicts an example computer system with a multi-phase web-page related payload mining engine.

### DESCRIPTION

The description that follows includes example systems, methods, techniques, and program flows that embody aspects of the disclosure. However, it is understood that this disclosure may be practiced without these specific details. In other instances, well-known instruction instances, protocols, structures and techniques have not been shown in detail in order not to obfuscate the description.

Overview

A variety of use cases (e.g., performance monitoring, customer experience analysis, etc.) employ NLP to extract meaningful information from web page related requests and responses. The information can be considered meaningful for identifying a class of web pages or identifying web pages with common content. Various analysis can then be carried out on the meaningful information within the context of the meaningful information identifying the class of web pages or similar web pages. Since NLP is resource intensive, using NLP for text mining or text analysis on a large number of web page related requests and responses between a client(s) and a server is prohibitively expensive to do on a request/response basis.

To extract meaningful information that aids in analysis of a web application based on page summarizations without impractical resource demand, statistical modeling is employed to approximately identify pages across web application transactions and predict meaningful content or items of information within the pages. Statistics are collected on a sample of traffic for a web application, which encompasses transactions formed by request-response message pairs or request-response pairs. The collected statistics are on tokens generated from message payloads and hypertext transfer protocol (HTTP) headers that correspond to web pages (e.g., requests submitted with forms or fields of web page and responses with payloads for a web page or content to update a web page). Statistics collected by “page” (i.e., message payloads and/or headers corresponding to a web page), by transaction, and across the samples. Descriptive tokens that meaningfully describe, at least partly, a web page and attribute-value pair tokens are scored. Those of the tokens that satisfy selection criteria are selected as a basis for generating extraction rules. Subsequently, the extraction rules are applied to message payloads to efficiently extract descriptive “tags” and attribute-value pairs. The scoring and selection criteria together eliminate information that are likely of no value or interest for analysis related to the web application, such as security tokens and other per-request data that is not descriptive of the purpose of the page. Thus, meaningful information items can be efficiently extracted and meaningfully organized by page summarization.

### Example Illustrations

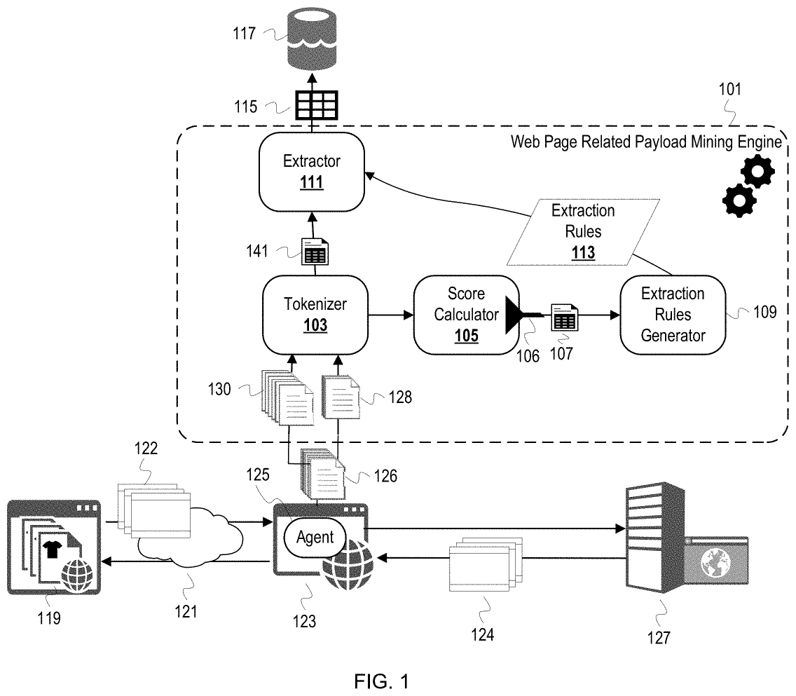

FIG. 1 is a diagram of a system that scores tokens of web page related message payloads for generating extraction rules to efficiently implement extracting of meaningful information. Information deemed as meaningful for application performance monitoring, flow analysis, etc., can be mined from messages observed by a web application. But the request and response messages exchanged between a client 119 and a front-end server 123 of a web application include a large amount of noise (e.g., page boilerplate). Request messages 122 are generated from interactions with a web page(s) rendered by the client 119 (e.g., a web browser). Payloads of these request messages can include field identifiers and data submitted into the fields, forms and data therein, etc. The front-end server 123 of the web application receives response messages 124 from a back-end server 127 of the web application. Additional back-end servers of the web application may interact with the front-end server 123, but only one is depicted for ease of illustration. The front-end server 123 may forward a response message to the client 119 or build at least a part of a web page from multiple response messages from the back-end server 127 and then communicate a response message to the client 119 with the resulting partial web page or web page as a payload (e.g., a JavaScript Object Notation (JSON) object or eXtensible Markup Language (XML) object).

An agent 125 (e.g., probe or instrument) captures messages received by the front-end server 123. To facilitate extraction of meaningful information (or predicted to be meaningful information), the agent 125 copies payloads 126 of the observed messages 122, 124. The agent 125 passes the payload copies 126 to a web page related payload mining engine 101. The web page related payload mining engine 101 (“mining engine”) comprises a tokenizer 103, a score calculator 105, an extraction rules generator 109, and an extractor 111. The mining engine 101 operates in a discovery/summarization phase and a rules driven extraction phase.

In the discovery phase, the tokenizer 103 analyzes each payload sample (i.e., the payloads 128 captured during the discovery phase) to generate tokens from each payload. This tokenization is done according to rules based on the underlying programming language(s) of the web age. For instance, the tokenizer 103 recognizes delimiters based on rules of hypertext markup language (HTML) and JavaScript, as examples. In addition, the tokenizer 103 applies classification rules that are also informed by the rules of the underlying programming language(s). For example, the tokenizer 103 may classify a token as an attribute-value pair token based on recognizing the assignment operation “=” and sets of encompassing brackets “< . . . >.” The tokenizer 103 may perform tokenization in multiple passes over a message payload. The tokenizer may first identify the smallest lexical units with delimiters and then start to combine these tokens into larger tokens based on binding or assignment operators. The tokenizer 103 can then distinguish between page attributes that name a property and attributes that are values of a named property. The tokenizer 103 passes the generated tokens to the score calculator 105.

The score calculator 105 computes statistics about the tokens for the message payload being analyzed and then scores the tokens. Scoring can be delayed in different embodiments. For example, the score calculator 105 may compute statistical information about tokens until the discovery phase ends, and then compute scores. The score calculator 105 may compute token scores by page, token scores by transaction, and token scores across transaction observed in the discovery phase. The score calculator 105 can then aggregate the multiple scores per token to generate an aggregated score for each token. The score calculator 105 then applies selection criteria 106 to select tokens predicted to be meaningful based on the scoring. The selection criteria 106 may define a window based on scores and indicate that candidate attribute-value pairs having scores outside of the window (i.e., in the margins) are to be excluded from consideration. A very high score suggests that a token appearing too frequently cannot meaningfully identify a web page or group of similar web pages. A very low score suggests that a token may be an outlier or an aberration and is not a meaningful descriptor and would not be meaningful in analyzing the web application.

To help illustrate, assume the snippet of text below was in a payload communicated to the mining engine 101 from the agent 125.

```
. . .
</head>
  <body class=“products-show” id=“default” data-hook=“body”>
    <div id=“blueprints-sidebar” class=“offcanvas-right
    offcanvas-fixed”>
      <button class=“close” data-dismiss=“offcanvas”>
        <span aria-hidden=“true”>&times;</span>
        <span class=“sr-only”>Close</span>
      </button>
      <h2>Create a Blueprint</h2>
      <div id=“blueprints-sidebar-container”></div>
  </div>
. . .
<h1 class=‘text-center-xs’ itemprop=‘name’>
Yuma Cotton Linen Stripe
<br class=‘visible-xs-inline’>
<span itemprop=‘offers’ itemscope itemtype=‘http://schema.org/Offer’>
<span class=‘variantprice’ itemprop=‘price’>
$129.00
</span>
<span content=‘USD’ itemprop=‘priceCurrency’></span>
<h4 class=‘text-center-xs text-muted’ itemprop=‘description’>
<em>30's Single-Ply, Cotton/Linen Poplin</em>
. . .
```

The tokenizer 103 tokenizes the text based on recognizing operators, delimiters, etc. The text can be pre-processed to discard text recognized as formatting related tokens and boilerplate. The tokenizer 103 also classifies the tokens. The tokenizer 103 may access grammar rules or a glossary to determine that an attribute without a corresponding value in brackets is a descriptor tag (e.g., itemprop=‘offers’). If an attribute is observed with a subsequent sequence of characters surrounded by “><,” then the token is an attribute-value pair token. An example listing of tokens and classifications of the above text is in the table below.

TABLE 1
Example Listing of Tokens

| Token | Class |
|---|---|
| body class=“products-show” | descriptor |
| <h2>Create a Blueprint</h2> | descriptor |
| class=‘text-center-xs’ | descriptor |
| itemprop=‘name’>Yuma Cotton Linen Stripe< | Attribute-value |
| itemprop=‘offers’ | descriptor |
| itemtype=‘http://schema.org/Offer’ | Attribute-value |
| itemprop=‘price’> $129.00 < | Attribute-value |
| content=‘USD’ itemprop=‘priceCurrency’ | Attribute-value |
| class=‘text-center-xs text-muted’ | Attribute-value |
| itemprop=‘description’> | Attribute-value |
| <em>30's Single-Ply, Cotton/Linen Poplin< | |

The score calculator 105 passes to the extraction rules generator 109 a structure 107 with the tokens having scores that satisfy the selection criteria 106. The extraction rules generator 109 generates extraction rules 113 for extracting these tokens. Some rules may be relatively straightforward rules that determine whether a token of a payload matches a selected token and extracting the token. Other rules may include contextual conditions for extraction (e.g., extract only if followed by an assignment operator), as well as conditional classification rules (e.g., classification dependent upon occurrence of a value within subsequent brackets). The extraction rules generator 109 generates an extraction rule set 113 based on the structure 107 and communicates the extraction rule set 113 to the extractor 111.

In the rules driven extraction phase, the mining engine 101 efficiently extracts meaningful tokens that descriptively identify a web page and tokens meaningful for analysis by applying the extraction rule set 113. The descriptive tokens are used as identifying information for captured payloads and effectively organize the extracted content or attribute-value pairs into a group that are collectively meaningful for web pages described by the one or more descriptive tokens. The payloads 130 captured by the agent 125 during the extraction phase are tokenized, as in the discovery phase, by the tokenizer 103. The tokenizer 103 generates tokens 141 for each captured payload and passes the tokens 141 to the extractor 111. The extractor 111 applies or executes the extraction rules 113 on the tokens 141 to extract and classify tokens. The extraction should yield one or more descriptive tokens that identify a web page or type of web page (e.g., pages that have product information) and content tokens or attribute-value tokens that are meaningful analysis information (e.g., product prices, product descriptions, etc.). The extractor 111 then stores the extracted tokens and classifications into a repository 117, such as a data lake.

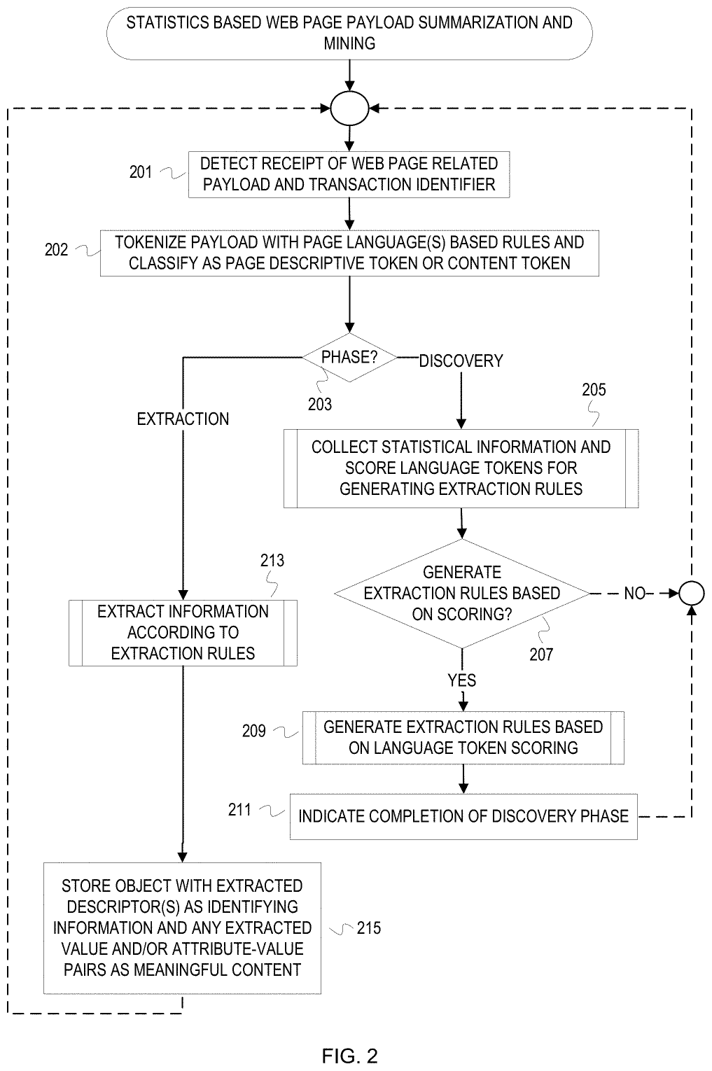

FIG. 2 is a flowchart of example operations for statistics based web page related payload summarization and mining. The example operations presume that a monitoring agent passes observed message payloads (or copies of message payloads) to a mining engine. FIG. 2 refers to a mining engine as performing the example operations for consistency with FIG. 1.

The mining engine detects receipt of a web page related payload and a transaction identifier (201). The payload may be from a request submitted from a web page of an application being monitored or a response to the request. When observed, a monitoring agent will assign a transaction identifier to the request message. The transaction identifier identifies the pairing of the request message and the resulting response. The mining engine can use the transaction identifier to later correlate a request payload or data about the request payload with a response payload or data about the response payload.

The mining engine then tokenizes the payload (202). The mining engine will tokenize the payload based on rules and a glossary or dictionary that correspond to the underlying programming language(s) of the web page payload. In addition, the mining engine classifies the tokens as descriptive tokens or content tokens (e.g., a token that includes an attribute name and a value assigned thereto). In some embodiments, the mining engine may not classify tokens until a determination of phase because extraction rules may dictate classification of tokens.

The mining engine determines a processing path for the tokens based on which phase the mining engine is currently operating in (203). The mining engine can be operating in a discovery phase or an extraction phase. In the discovery phase, the mining engine is discovering meaning information in observed web-page related payloads based on statistics of derived language tokens. In the extraction phase, the mining engine applies extraction rules generated after completion of the discovery phase. A criterion for ending the discovery phase may be a sample size (e.g., number of observed payloads from request-response pairs captured by a monitoring agent from data traffic of a web application), time based, or manually specified. Embodiments may repeat the discovery phase to update or revise extraction rules. The repeat of the discovery phase can be triggered on-demand, periodically based on a defined time period(s), based on a volume of payloads extracted, etc.

If the mining engine is in the discovery phase, then the mining engine collects/calculates statistical information about the tokens and scores the tokens based on the statistical information (205). Although the mining engine can calculate the statistical information (e.g., frequency of occurrence of a token, frequency of occurrence of a value in a token with a given attribute, etc.), the mining engine can also invoke functions from a library or application programming interface (API) of a statistics module. After scoring, the mining engine determines whether extraction rules are to be generated based on the scoring of tokens (207). If so, then the mining engine generates a set of extraction rules based on the token scoring (209). Otherwise, the mining engine waits for a subsequent payload. After generating the extraction rules, the mining engine indicates completion of the discovery phase (211). For instance, the mining engine sets a state value or flag representing completion of the discovery phase or switch to extraction phase.

If the mining engine is in the extraction phase, then the mining engine extracts information from the payload according to the extraction rules (213). The mining engine will record tokens and classify recorded tokens as specified by the extraction rules. In addition to identifying a token for extraction and classification for the token, the extraction rules may specify extraction conditions based on context (e.g., only extract a first occurrence of the token or only extract the token and classify as a descriptor if occurring within <h1> tags).

After extracting the information from the payload according to the extraction rules, the mining engine stores an object or adds an entry to a repository (215). As an example, the mining engine can populate fields of an object designated as descriptor fields with descriptive tokens and populate fields of an object designated as analysis items or meaningful content with attributes and/or values of attribute-value tokens. The mining engine can then store the populated object into the repository with an index or an identifier of the transaction (e.g., a request message-response message identifier pairing). The mining engine can also use the descriptive tokens as tags for the object or entry when storing into the repository. Thus, a search for meaningful content to generate a report on product pages would retrieve objects tagged with “product” and “description” descriptive tokens.

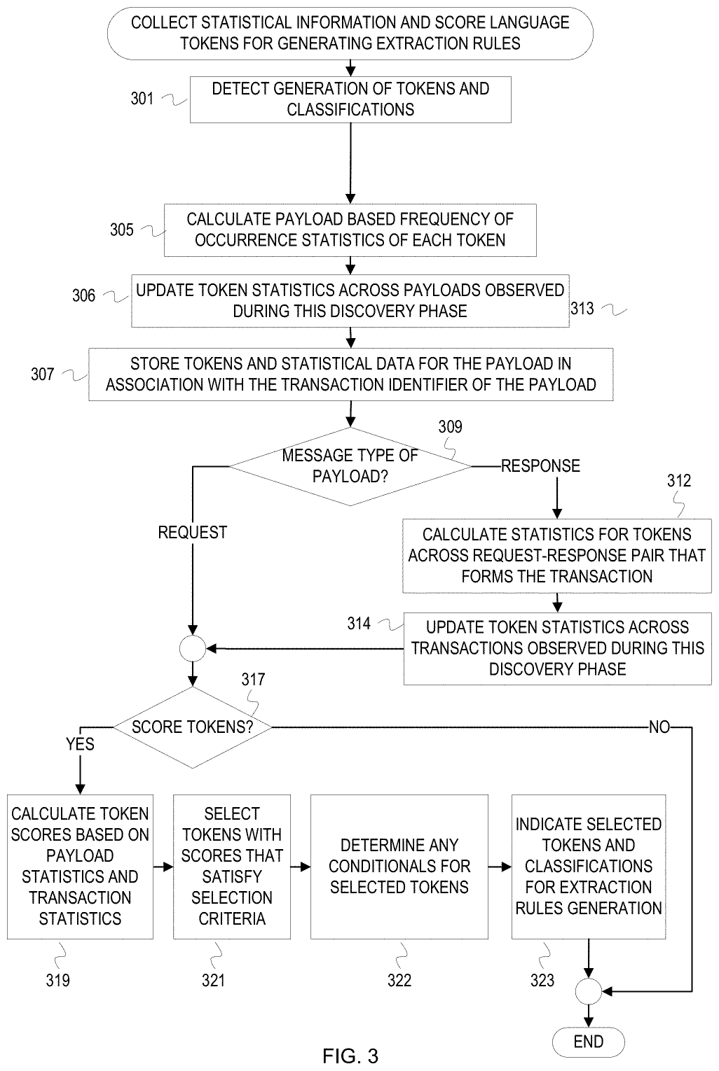

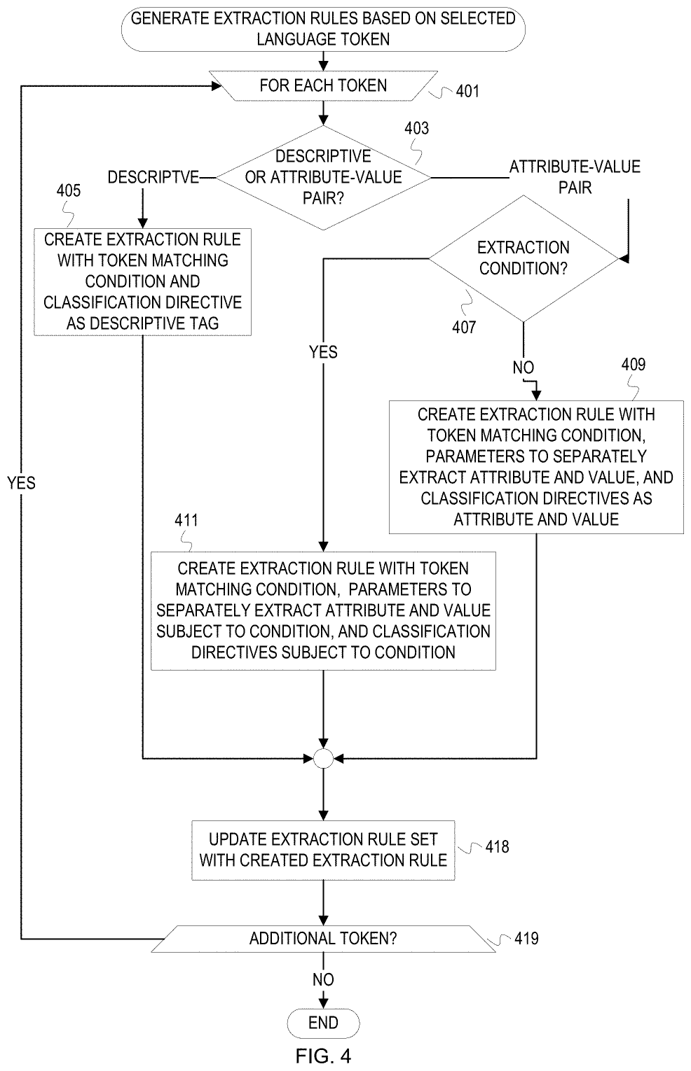

FIG. 3 is a flowchart of example operations for calculating or collecting statistical information of language-based tokens and scoring the tokens for generating extraction rules. The FIG. 3 description refers to a mining engine as performing the example operations for consistency with the preceding description. FIG. 3 is an example that corresponds to 205 of FIG. 2.

The mining engine detects generation of tokens and classifications of those tokens (301). As already described, a tokenizer will have analyzed a payload to generate tokens and classifications of those tokens based on the corresponding programming language(s) of the payload.

The mining engine then calculates payload based frequency of occurrence statistics of each generated token for the payload (305). Examples of frequency of occurrence statistics include frequency of occurrence within the set of tokens generated by the tokenizer from the payload, frequency of occurrence of an attribute across tokens with different values for the attribute, frequency of occurrence of a token in different sections of the payload, etc.

The mining engine then proceeds to calculate frequency statistics for tokens across payloads observed during the current discovery phase (306). The mining engine also updates statistics across transactions observed to this point during the discovery phase (e.g., frequency of occurrence of a token across all payloads, number of payloads in which a token occurs, etc.) Since the mining engine processes payloads that can correspond to multiple web pages that are instances of a same type of web page (e.g., product pages for different products) or multiple web pages of different types (e.g., shopping cart pages and product pages), these pages may or may not be distinguished based on the statistical data about the tokens. The mining engine stores this statistical information in a database or store in association with a transaction identifier for the payload (307). This allows the mining engine to retrieve request statistics when a payload of a corresponding response is received.

Based on whether or not the payload corresponds to a request or response message captured by a monitoring agent (309), the mining engine either continues with calculating additional transaction based token statistics (312) or a determination of whether or not to score the tokens (317). If the current payload is from a response message, then the mining engine updates transaction based statistics. Since the payload is from a response message, the mining engine should have stored payload statistics from a corresponding request message. The mining engine retrieves those statistics and calculates token statistics for the transaction formed by the request-response message pair (312). Examples of the transaction based statistics include frequency of a token with a same attribute in both the request and response payload but different values and token frequency different between the request and the response payloads. The mining engine also calculates and updates cross-transaction token statistics based on the token statistics of the transaction for the current payload (314). Examples of the cross-transaction token statistics include number of transactions in which a token occurs in both the request and response, number of transactions in which a token has a same attribute in both the request and response but different values, and ratio of response payloads to request payloads that include a token.

After statistical data has been calculated and/or updated, the mining engine determines whether to score tokens to guide extraction rule generation (317). This determination can be made based upon different factors in different embodiments or implementations. The mining engine may score tokens after determining token statistics for each payload. However, the scores would be updated based upon statistic updates due to additional sample observations during the discovery phase. FIG. 3 example operations are based on delaying scoring until a scoring criterion is satisfied. This may correspond (or be) the end of discovery phase criterion (e.g., sample size satisfied). If token scoring is not to be performed, then the process ends until tokens are generated for another payload.

If scoring is to be done, then the mining engine calculates token scores based on payload statistics (token statistics with respect to individual payloads) and transaction statistics (token statistics from the transaction perspective) (319). The mining engine can score descriptive tokens based on frequency of occurrence of each descriptive token across all transactions. The mining engine can consider other factors in scoring a descriptive token and calculate a score based on frequency of occurrence of the descriptive token in response payloads and/or as a function of number of transactions that include the descriptive token regardless of whether in a response or request payload. For content tokens or attribute-value pair tokens, the mining engine scores token based on the constituent attribute and value. Equation 1 below is one example of a scoring function based on frequency of occurrence of constituents of an attribute-value pair token.

$$\text{score} = \frac{named\_attribute \_frequency}{value\_frequency \_for \_named {\_attribute}^{2}} \qquad ( Equation 1 )$$

The mining engine determines frequency of occurrence of each named attribute (i.e., attribute identifier or attribute name) and assigns that to the variable named_attribute_frequency. The mining engine also determines frequency of occurrence of each value per named attribute and assigns that to the variable value_frequency_for_named_attribute. In addition, the mining engine may maintain statistics about the token scores and a history of the token scores within a discovery phase. This may aid the mining engine in differentiating classes of web pages by surfacing significant varying of scores for token across discovery phases. Embodiments can calculate multiple scores for a token, such as a transaction-based score and a payload-based score. For instance, the mining engine can calculate a payload-based score based on frequency of occurrence of a token across observed payloads during the discovery phase and a transaction-based score based on frequency of occurrence across transactions.

The mining engine then selects those of the tokens with scores that satisfy selection criteria (321). Assuming a token is assigned a single score based on the analysis during the discovery phase, the mining engine determines whether that score satisfies selection criteria that defines a range or window of “meaningful” scores. The criteria can be a ceiling score and a floor score. A satisfying score would be a score that falls within the range/window defined by the ceiling and floor scores. Implementations can define the criteria as exclusive or inclusive of the ceiling and floor scores. The selected attribute-value pairs are selected as being meaningful information.

For the selected tokens, the mining engine determines any conditionals for selected tokens (223). For instance, a descriptive token may be considered meaningful (i.e., identified for extraction) at first occurrence within a payload because transaction-based scoring satisfied the selection criteria while payload-based scoring did not. With respect to attribute-value pairs, an extraction conditional may specify that only the value is to be extracted or that the attribute-value token is to be extracted from response payloads only. The mining engine then indicates the selected tokens, classifications, and conditions for generating extraction rules (323).

FIG. 3 is a flowchart of example operations for generating extraction rules based from selected tokens. FIG. 3 refers to the mining engine as performing the example operations for consistency with the preceding description.

The mining engine generates an extraction rule for each token selected as meaningful for mining and analysis (401). The mining engine can iterate over the listing of selected tokens. Rule generation can depend upon the type or class of token, so the mining engine determines whether each token is a descriptive token or an attribute-value pair token (403).

If the token is a descriptive token, then the mining engine creates an extraction rule with a token matching condition and a classification directive as descriptive tag (405). The extraction rule will identify the token for matching and have code or a parameter that specifies classification of the extracted information as a descriptive tag for the page payload.

If the token is an attribute-value pair token (403), then the mining engine determines whether one or more extraction conditions have been defined for the token (407). If an extraction condition has been defined, then the mining engine creates an extraction rule that identifies the token for matching, extraction parameters subject to the condition, and classification directives subject to the condition (411). In addition to identifying the token for the extraction rule, a condition may specify that only the attribute name be extracted or only the value assigned be extracted. The classification directive can then be to classify the extracted information as field value or attribute name. Extraction parameters may specify that encountered apostrophes or dashes be ignored. The mining engine can be programmed to load extraction parameters or be programmed with extraction parameters defined that recognize delimiters to guide extraction. For instance, general or default extraction parameters may be to extract all characters occurring between quotation marks that occur after an assignment operator (e.g., ‘=’) following the paired attribute. Extraction parameters can be defined by value type. In addition, extraction parameters can be defined for an attribute to supersede generating extraction parameters since delimiters may vary.

If no extraction condition is associated with the attribute-value pair token (407), then the mining engine creates an extraction rule that identifies the attribute-value token for matching, extraction parameters, and classification directives (409). The extraction rule would identify the token to match, parameters on how to separately extract the attribute name and assigned value, and classification directive to classify the extracted attribute name and extracted value.

After creation of the extraction rule, the mining engine updates an extraction rule set with the created extraction rule (418). The mining engine proceeds to the next selected token, if any (419).

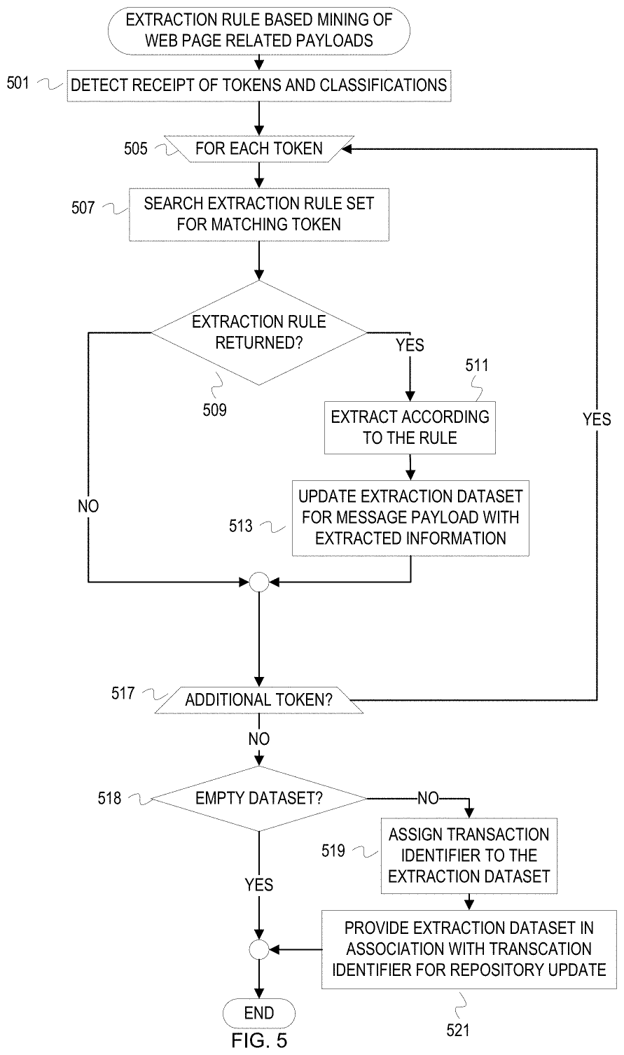

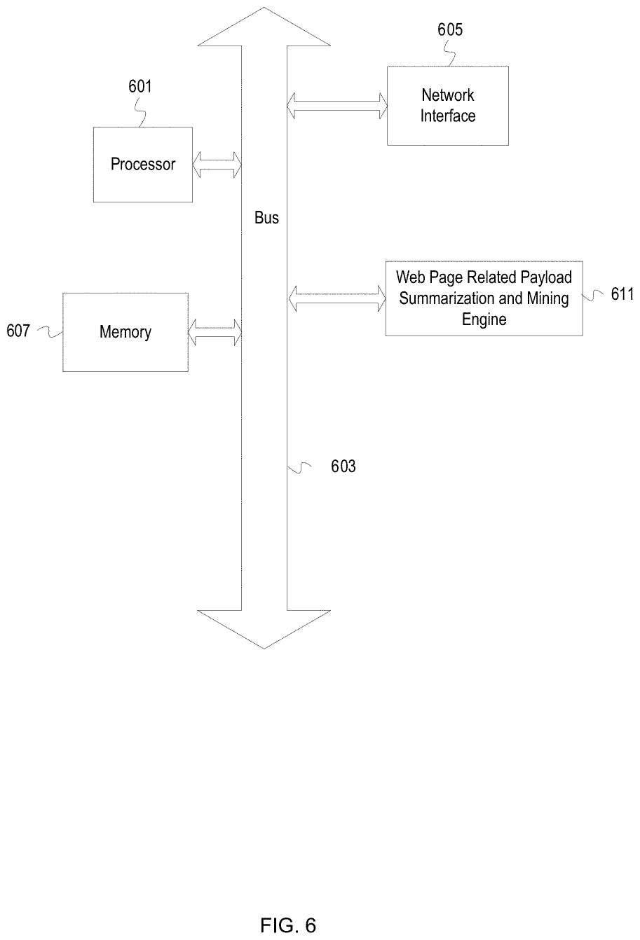

FIG. 5 is a flowchart of example operations for extraction rule based mining of web page related payloads of request and response messages of a web application or website. The FIG. 5 description continues referring to a mining engine as performing the example operations. For FIG. 5, the discovery phase has ended and the mining engine is applying the previously generated extraction rules to token generated from message payloads communicated to the mining engine from a monitoring agent. These example operations relate to an embodiment in which the monitoring agent passes payloads to the mining engine. In some embodiments, the monitoring engine passes captured messages to the mining engine and the mining engine extracts the payloads.

Based on detecting receipt of tokens and classifications (501), the mining engine begins scanning the received tokens (505) and determining whether an extraction rule applies to the scanned token (507). Determining a match varies depending upon implementation of the extraction rules. For instance, the extraction rules can be a repository of rules indexed by the meaningful tokens. If an extraction rule is not returned for the scanned token (509), then the mining engine scans the next token (517). If an extraction rule is returned from searching the extraction rule set, then the mining engine extracts the token according to the rule (511). As described earlier, this can be storing the token with the classification as directed by the extraction rule. The extraction rule may have sanitizing or normalizing parameters (e.g., remove certain characters, remove only the value, etc.). The mining engine then updates an extraction dataset for the message payload corresponding to the generated tokens with the information that has been extracted (513).

Once the mining engine has finished scanning the tokens generated from the message payload (517), the mining engine determines whether the extraction dataset is empty (518). In some cases, none of the generated tokens match an extraction rule in the extraction rule set so there would be no mined information to store. Embodiments can record this result, though. It may be useful for later rules revision to know the amount of traffic for which no meaningful information was found. If the dataset is empty (or not created), then the process ends until the next payload capture. If the dataset is not empty, then the mining engine assigns a transaction identifier to the extraction dataset (519). This is not necessary but can aid in organizing information later. With the transaction identifier associated, the mining engine provides the extracted dataset for update of a repository of extracted information for a web application or web site (521).

Variations

If extraction rule sets are constructed for different web page classes, then extraction rule sets for different web page classes can be applied. An appropriate rule set can be determined based on header information in captured messages. In this case, message headers could be preserved with the payloads to guide selection of an extraction rule set.

The example illustrations refer to the mining engine operating in different phases. Embodiments may not transition the mining engine between the different phases of operation. Embodiments may instantiate different threads or processes to carry out the functionality corresponding to the different phases.

The above description refers to updating or revising extraction rules in subsequent discovery phases. To update or revise extraction rules, resulting scores for the triggered discovery phase can be used alone in changing a rule or rules in an extraction rule set. Embodiments can maintain at least partial history of scores and aggregate the historical scores with the current score, and update the extraction rule set based on the aggregated scores. Embodiments may maintain at least a partial history of statistical data from one or more previous discovery phases and generate new scores based on an aggregation of the statistical data across multiple discovery phases. Updating an extraction rule set can be removing a rule, adding a rule, or modifying a rule. Modifying a rule can be changing a search condition, adding an extraction parameter, removing an extraction parameter, and/or changing an extraction parameter.

In addition, embodiments should not be limited to message payloads. As mentioned earlier, meaningful information can also be extracted from message headers. Embodiments can capture the entire message include header and payload and tokenize the header and the payload. The classification rules of the tokenizer can specify that tokens in the header are descriptive tokens. Furthermore, the scoring can be weighted depending upon whether a token occurs in a header or a payload.

The examples often refer to a “mining engine” as well as other components of the disclosed system. The mining engine is a construct used to refer to implementation of the disclosed functionality. This construct is utilized since different implementations and different naming conventions are possible for program code, libraries, etc. Modularization of functionality can vary based on platform, programming language(s), developer preferences, etc.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain, or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

FIG. 5 depicts an example computer system with a multi-phase web-page related payload mining engine. The computer system includes a processor 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505 (e.g., a wired or wireless interface). The system also includes a multi-phase web-page related payload mining engine 511 (“mining engine”). The mining engine 511 analyzes data traffic to score tokens based on statistical data calculated/captured for the tokens and then generates extraction rules based on the scoring. The two phases or modes of operation for the mining engine include a first phase to discover one or more tokens that meaningfully describe a web page or group of similar web pages. The first phase also involves identifying meaningful attribute-value tokens that may be used in reports or analysis. The descriptive token(s) effectively identifies the set of attribute-value tokens as a coherent unit corresponding to a web page or similar web pages. The mining engine generates an extraction rule set based on the meaningful tokens. In the second phase or mode, the mining engine applies the extraction rule set to mine live traffic. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

While the aspects of the disclosure are described with reference to various implementations and exploitations, it will be understood that these aspects are illustrative and that the scope of the claims is not limited to them. In general, techniques for mining as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
identifying lexical tokens in web page related messages sampled from first data traffic;
determining statistics about the lexical tokens per message and across messages sampled from the first data traffic;
calculating scores for the lexical tokens based, at least in part, on the statistics;
selecting a subset of the lexical tokens based, at least in part, on distribution of the scores;
generating extraction rules to extract data from web page related messages, wherein the extraction rules are generated based on the subset of lexical tokens; and
extracting data from web page related messages in second data traffic according to the extraction rules.

2. The method of claim 1, wherein selecting the subset of the lexical tokens based, at least in part, on the distribution of the scores comprises determining those of the tokens with calculated scores that fall insides of a highest percentage of scores and a lowest percentage of scores.

3. The method of claim 1, wherein selecting the subset of the lexical tokens based, at least in part, on the distribution of scores comprises selecting those of the lexical tokens that have a score within a range defined by a floor score and a ceiling score.

4. The method of claim 1 further comprising classifying the identified lexical tokens as a descriptive token or an attribute-value pair token, wherein a lexical token is classified as a descriptive token if a candidate for being a descriptive tag for a web page and a lexical token is classified as an attribute-value pair token based on having an attribute and a value therein.

5. The method of claim 1, wherein calculating the scores comprises, for each of the lexical tokens classified as an attribute-value pair token, calculating a first score as a quotient of a frequency of occurrence of the attribute and a square of a frequency of occurrence of the value paired with the attribute in the attribute-value pair token.

6. The method of claim 5, wherein the frequency of occurrence is per message or per transaction as defined by request and response messages.

7. The method of claim 5 further comprising calculating, for each of the lexical tokens, a second score based on frequency of occurrence of the lexical token across the messages sampled from the first data traffic.

8. The method of claim 1, wherein generating the extraction rules comprises forming an extraction rule based on each of the subset of lexical tokens.

9. The method of claim 8, wherein forming an extraction rule based on each of the subset of lexical tokens comprises forming the extraction rule with a condition to match the lexical token and a set of one or more extraction parameters.

10. The method of claim 8, wherein the set of one or more extraction parameters indicate at least one of a condition for extracting and how to extract the token or a part of the token.

11. The method of claim 1, wherein identifying lexical tokens in web page related messages comprises identifying lexical tokens in at least one of a message header and a message payload, wherein a message payload comprises at least one of a JavaScript Object Notation object and an eXtensible Markup Language object.

12. The method of claim 1, wherein extracting data from messages of second data traffic according to the extraction rules comprises tokenizing a message to generate tokens from the message and scanning each generated token against each rule of the extraction rules until matching a token indicated in the extraction rule.

13. A non-transitory, computer-readable medium having instructions stored thereon that are executable by a computing device to perform operations comprising:
tokenizing web page related request and response messages of data traffic for a web site or web application to generate tokens
classifying each generated token as a descriptive token or an attribute-value pair token;
determining frequency of occurrence of the tokens across a first sample of web page related messages in the data traffic;
selecting as significant those of the tokens from the first sample with a frequency of occurrence that satisfies selection criteria; and
generating extraction rules for extracting from web page messages those of the tokens determined as satisfying the selection criteria.

14. The non-transitory, computer-readable medium of claim 13 further comprising applying the extraction rules to web page related messages outside of the first sample.

15. The non-transitory, computer-readable medium of claim 14, wherein applying the extraction rules to web page related messages outside of the first sample comprises scanning a set of one or more tokens generated from tokenizing a web page related message outside of the sample against each of the extraction rules until triggering one of the extraction rules, wherein triggering an extraction rule comprises determining that the scanned token matches a token indicated in the extraction rule.

16. The non-transitory, computer-readable medium of claim 13, wherein the instructions are further executable by a computing device to perform operations comprising collecting different statistics about the tokens from the sample, wherein the different statistics include the frequency of occurrence of tokens across the sample and frequency of occurrence of attributes with different values in the attribute-value pair tokens.

17. The non-transitory, computer-readable medium of claim 13, wherein the instructions are further executable by a computing device to perform operations comprising determining frequency of occurrence of tokens from a second sample of web page related messages and updating the extraction rules based on at least one of change in frequency of occurrence of at least one of the tokens and determining that an additional token satisfies the selection criteria based, at least in part, on a frequency of occurrence of the additional token.

18. An apparatus comprising:
a processor; and
a computer-readable medium having instructions stored thereon that are executable by the processor to cause the apparatus to,
for a first phase,
tokenize first web page related messages and classify each token as a descriptive token or an attribute-value pair token;
score the tokens based on statistics related to frequency of occurrence of the tokens per message and across the first web page related messages and score the attribute-value pair tokens based on statistics related to frequency of pairing of attribute and values in the attribute-value pairs in the first web page related messages; and
generate a first set of extraction rules to extract a subset of the tokens from web page related messages based on scores of the subset of the tokens satisfying ceiling and floor thresholds for scores;
for a second phase, tokenize second web page related messages and extract tokens from the second web page related messages according to the first set of extraction rules.

19. The apparatus of claim 18, wherein the computer-readable medium further has instructions executable by the processor to cause the apparatus to determine the statistics of the tokens in the first phase.

20. The apparatus of claim 18, wherein the computer-readable medium further has instructions executable by the processor to cause the apparatus to determine, for the first phase, which of the tokens have scores satisfying the ceiling and floor thresholds.
